(19) United States
(12) Patent Application Publication
(10) Pub. No.: US 2009/0173403 A1
(43) Pub. Date: Jul. 9, 2009

(54) DUAL LIFT VALVE FOR RECIPROCATING COMPRESSOR AND PUMPS

(76) Inventors: Philip Hunt, Burbage (GB); H. Eugene Bassett, Sugar Land, TX (US)

Correspondence Address: SYSTEM DYNAMICS, 4126 HENLEY COURT, SUGAR LAND, TX, 77479, US

(21) Appl. No.: 11/969,255

(22) Filed: Jan. 4, 2008

(51) Int. Cl. F16K 15/00

(52) U.S. Cl. 137/540

(57) ABSTRACT

The invention provides a unique self actuating mechanical dual lift control for valves used in reciprocating compressors and pumps. The primary motivation for this concept is the ability to avoid expensive shutdown to change valves when compressor services change. The dual lift valve concept reduces valve power consumption by permitting a secondary lift to increase flow area at or near the peak piston speed. This concept may be retrofitted to some existing valves.

### TECHNICAL FIELD AND INDUSTRIAL APPLICABILITY OF THE INVENTION

This present invention relates to valves that may be used for intake or outlet of gases or liquids for reciprocating compressors and pumps.

### DESCRIPTION

The operative portion of such a compressor and pump includes at least one piston and cylinder assembly and the intake and exhaust valves are typically located at or near one of the cylinder heads. It is commonly known to use the same form of valve for both inlet and outlet by simply reversing the position of the valve for the two uses. One such valve is disclosed in U.S. Pat. No. 5,511,583 by Bassett which has singular annular valve elements. The present invention differs in that the valve elements are multiple or singular annular valve elements. Also, unlike U.S. Pat. No. 5,511,583 the present invention has two stop surfaces per element as well as two sets of springs with differing initial loads biasing it closed, i.e. toward its seating surface in to and fro movement.

The present invention is similar to what is generally known as “ring-type” or “ported plate”. The elements of traditional valves have a sealing surface to contact the valve seat to prevent back-flow as the valve element moves to and fro with reciprocating movement. These valves elements move from fully seated to full open in one step.

The present invention valve elements are different from traditional valve elements in that two steps define full open whereas traditional elements move from fully seated to full open in one step.

U.S. Pat. No. 3,862,751 by Schwaller claims a dual stage spring assembly consisting of an outer and inner spring to cushion valve opening impact.

U.S. Pat. No. 3,507,486 by Schwaller claims spring assemblies and the abstract makes it clear that these spring assemblies are concentrically disposed.

Both patents specify different spring rates.

The present invention stipulates separately disposed springs to provide different valve lifts within a common valve assembly to accommodate alternate services and to reduce power consumption.

### SUMMARY OF THE INVENTION

A compressor and pump inlet or outlet valve according to the present invention comprises a seating plate and a guard plate removable attached in opposed relation to make up the valve body. The seating plate has a plurality of holes or slots extending from an outer side of the seating plate to the inner side. The guard plate defines a respective stop surface generally opposed to but spaced from the seating surfaces associated with each seat hole or slot. The guard plate also has flow passages from the inner to the outer side thereof and communicating with the spaces between the stop surfaces and the seating surfaces. A respective valve element reciprocates between the stop surfaces and the respective opposed seating surfaces and have sealing surfaces sized and shaped to engage and seal against the respective seating surfaces. A multiplicity of springs carried by the guard plate engages a respective valve element to bias it toward the respective sealing surfaces. The detailed description below describes the reasons and benefits associated with this invention. Various objects, features and advantages of the invention will be made apparent by the following detailed description, the drawings, and the claims.

### DETAILED DESCRIPTION

### BRIEF DESCRIPTION OF THE DRAWINGS

FIG. 1 is a top plan view of the device.

FIG. 2 is a cross-sectional view of the present invention taken along the line 1-1 in FIG. 1, showing the device in the closed position.

FIG. 3 is a plan view taken along the line 2-2 in FIG. 2.

FIG. 4 is a cross-sectional view of the present invention taken along the line 1-1 in FIG. 1, showing the device in the first lift position.

FIG. 5 is a cross-sectional view of the present invention taken along the line 1-1 in FIG. 1, showing the device in the second lift position.

FIG. 6 is an alternate opposite plan view of the present invention.

FIG. 7 is a cross-sectional view taken along the line 3-3 in FIG. 6.

FIG. 8 is a velocity—piston position diagram.

FIG. 9 is a pressure—volume diagram for the device in the first lift position.

FIG. 10 is a pressure—volume diagram for the device in the second lift position

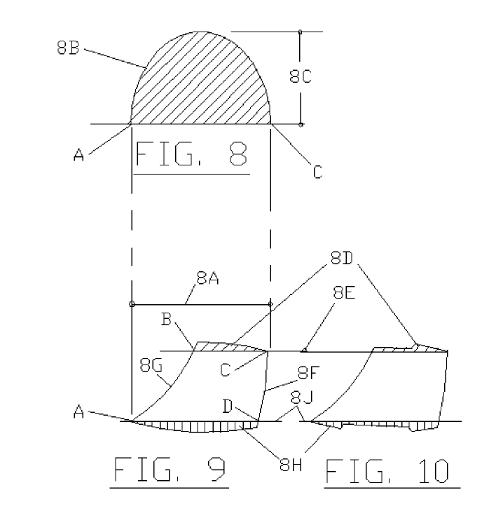

FIG. 8 thru 10 illustrates the fundamental principles of how the instantaneous piston position influences reciprocating compressor valve opening and closing. Referring to FIG. 8 and FIG. 9, the piston stroke is represented by 8A and the piston velocity is zero A and C at each end of the piston stroke. 8G is the compression event from A to B. Area bounded by A-B-C-D is compression power required to elevate pressure from 8J to 8E. Area 8H is inlet parasitic inlet valve power and area 8D is outlet valve parasitic power. As shown, outlet valve opening B occurs near peak piston velocity 8C. At D the inlet valve opens near minimum piston velocity.

Comparing FIG. 9 with FIG. 10 clearly shows the advantage of dual lift valves to reduce power consumption. Reducing power consumption is only one advantage to the present invention. Many compressors operate under varying gas conditions from light to heavy mol weight as well as alternate pressures.

Compressor valves are generally designed for longevity based on the normal operating condition. Alternate services result in less than optimum performance. For example: Valves designed for hydrogen must be low lift to avoid “flutter” a condition where sealing elements vibrate at high rates. Due to the high rate of vibration the sealing elements and springs quickly wear out. In an alternate high mol weight or higher pressure condition the same valves are subject to late closure, high impact and result in recirculation of hot gas. If this condition exists for longer than a few hours the valves may self-destruct. As a minimum higher parasitic power will be encountered.

The other alternative is to maintain two separate valve designs; one low lift for normal and one high lift for the alternate use. If this route is taken, it would be necessary to shutdown the compressor and change the valves. Valve change is very expensive and time consuming. Before returning to normal operation this process must be repeated.

As the foregoing suggests, a valve dual lift valve design is desirable for operating cost reduction and to reduce power consumption.

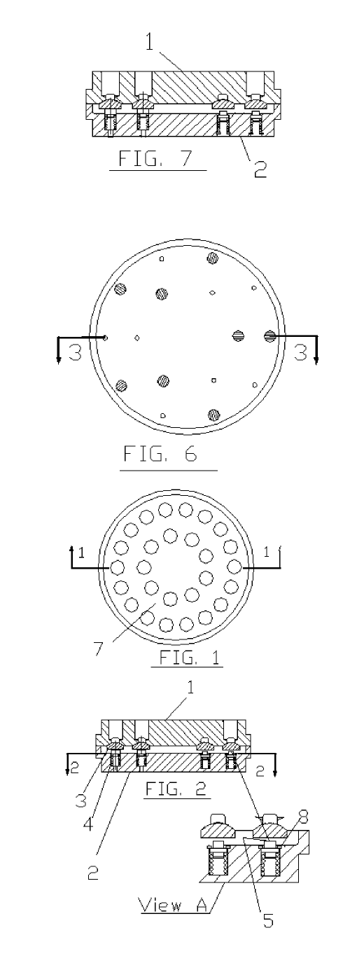

FIGS. 1 thru 5 illustrate a first embodiment of compressor valve according to the present invention. As shown, this, and all the other embodiments disclosed herein can be oriented for use as an intake or outlet valve by simply reversing its orientation as is well known in the art. The valve comprises a seating plate 1 and a guard plate 2 secured together in opposing relation to form the valve case.

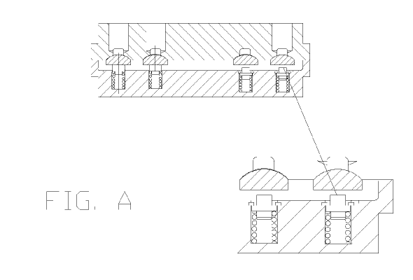

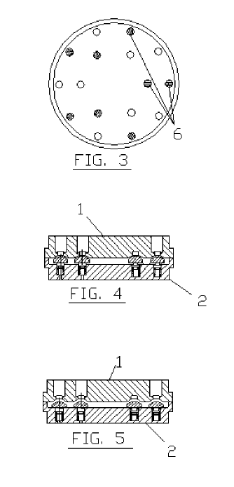

The seating plate has a plurality of flow passages (holes and/or slots) extending from its outer surface 7. The guard plate 2 includes one or more seal members 3 biased toward the seat by a multitude of springs 4 for a closed position FIG. 2. When the flowing forces are greater than the sum of valve spring 4 loads, the seal members 3 move to a first stop position FIG. 4. At the first stop position the flowing forces then must further increase to a value greater than the sum of valve spring 4 loads plus sum of spring 9 preload for seal members 3 to move to stop position 2. Dual lift control components consist of button 5, spring 9 and retaining ring 8. FIG. 3 illustrates the dual lift control features as crosshatched holes 6.

Referring next to FIG. 6 and FIG. 7 there is shown a second embodiment of the invention, which is generally the same as the first embodiment except that the first stop elements are installed from the back side of guard plate 2 instead of facing seating plate 1.

While the foregoing represents exemplary and currently preferred embodiments of the present invention, numerous modifications will suggest themselves to those of skill in the art. Accordingly, it is intended that the scope of the invention be limited only by the following claims.

What is claimed is:

1. A valve for inlet or outlet of gas and liquids with respect to reciprocating compressors and pumps, comprising: lift control members in cavities on the seat side of the guard consisting of a multitude of resilient variable force generating members to define a primary lift and secondary lift; said primary lift is achieved by said lift control members, said lift control members include a multitude of projections from guard plate toward seal members to define said primary lift and to inhibit said secondary lift.

2. A device according to claim 1 wherein said lift control members are in said cavities opposite said seat side.

3. A device according to claim 1 wherein said resilient variable force generating members are coil springs.

4. A device according to claim 1 wherein said projections are non-metallic material.

5. A device according to claim 1 wherein said projections are metallic material.

6. A device according to claim 1 wherein said projections and said resilient variable force generating members are physically restrained to maintain said primary lift.

7. A device according to claim 2 wherein said resilient variable force generating members are coil springs.

8. A device according to claim 2 wherein said projections are non-metallic material.

9. A device according to claim 2 wherein said projections are metallic material.

10. A device according to claim 2 wherein said projections and said resilient variable force generating members are physically restrained to maintain said primary lift.
